(19) United States
(12) Patent Application Publication
(10) Pub. No.: US 2015/0169491 A1
(43) Pub. Date: Jun. 18, 2015

(54) ELECTRONIC DEVICE USING USB SOCKET TO LOAD FIRMWARE AND FIRMWARE LOADING METHOD THEREOF

(71) Applicant: Primax Electronics Ltd., Niehu (TW)

(72) Inventors: YI-GUANG CHEN, Taipei (TW); Yu Yen Shih, Taipei (TW)

(73) Assignee: Primax Electronics Ltd., Niehu (TW)

(21) Appl. No.: 14/252,007

(22) Filed: Apr. 14, 2014

(30) Foreign Application Priority Data
Dec. 13, 2013 (TW) 102146098

(51) Int. Cl. G06F 13/40; G06F 13/24

(52) U.S. Cl. CPC G06F 13/4068; G06F 13/24

(57) ABSTRACT

An electronic device using a USB socket to load firmware and a firmware loading method are provided. The electronic device includes a USB socket, a functional chip, and a switching element. The switching element is connected with a bus data transmission pin of the USB socket and a chip data transmission pin of the functional pin. When a high-level voltage is provided to an identification pin of the USB socket, the switching element is turned on. Under this circumstance, the connection between the bus data transmission pin and the chip data transmission pin is established. Consequently, a firmware data can be successfully transmitted to the functional chip through the USB socket.

### FIELD OF THE INVENTION

The present invention relates to an electronic device, and more particularly to an electronic device using a USB socket to load firmware.

### BACKGROUND OF THE INVENTION

With increasing development of information technologies, portable electronic devices become more and more popular. Since the current computer system has powerful multimedia processing functions, various portable electronic devices can be directly in communication with the computer system to perform various data transferring tasks. As known, a universal serial bus (USB) interface is one of the most popular connecting interfaces between the portable electronic device and the computer system. The reason is that the USB interface has many benefits such as the plug and play capability, the hot plug capability, the high transmission speed, and the like.

More especially, the universal serial bus also has the function of transferring an electric current. Consequently, the computer system may provide electric power to the portable electronic device through the USB interface. By acquiring the electric power, the portable electronic device can be normally operated. Alternatively, the computer system may provide the electric power to charge a battery of the portable electronic device. Moreover, the USB interfaces of some portable electronic devices are designed to receive external electric power but do not have the functions of exchanging data with the computer system.

FIG. 1 is a schematic circuit block diagram illustrating an electronic device with a function of exchanging data with a computer system according to the prior art. As shown in FIG. 1, the electronic device 1A comprises a universal serial bus (USB) socket 11A, a functional chip 12A, a charging chip 13, and a battery 14. The battery 14 is connected with the charging chip 13. Moreover, the functional chip 12A comprises firmware for executing specified functions. For example, in case that the electronic device 1A is a USB flash drive, the functional chip 12A is responsible for transmitting data, storing data or retrieving data. Moreover, the functional chip 12A comprises a first device identification pin 123 and a second device identification pin 124. The USB socket 11A comprises a VBUS pin 111, a D− pin 112, a D+ pin 113, an ID pin 114, and a GND_DRAIN pin 115. The GND_DRAIN pin 115 of the USB socket 11A is connected to ground. The VBUS pin 111 of the USB socket 11A is connected to the charging chip 13. The D− pin 112 and the D+ 113 pin of the USB socket 11A are connected to the first device identification pin 123 and the second device identification pin 124 of the functional chip 12A, respectively. The ID pin 114 is in a floating state or connected to ground according to the practical requirements. In case that the USB socket 11A complies with an On-The-Go (OTG) specification, the ID pin 114 is connected to ground. Whereas, in case that the USB socket 11A does not comply with the OTG specification, the ID pin 114 is in the floating state.

When two plugs 31 and 32 at both ends of a USB cable 3 are respectively plugged into the USB socket 11A of the electronic device 1A and a USB socket 21 of the computer system 2, the electronic device 1A is connected with the computer system 2 through the USB cable 3. Under this circumstance, the electric current provided by the computer system 2 may be transmitted to the charging chip 13 through the USB cable 3 and the VBUS pin 111 of the USB socket 11A sequentially. Consequently, the battery 14 is charged by the electric current. Generally, in case that the USB interface is a USB2.0 interface, the computer system 2 is able to provide an electric current of about 500 mA to the electronic device 1A. Whereas, in case that the USB interface is a USB3.0 interface, the computer system 2 is able to provide an electric current of about 900 mA to the electronic device 1A.

At the same time, the computer system 2 issues a query message S1. The query message S1 is transmitted to the functional chip 12A through the USB cable 3, the D− pin 112 of the USB socket 11A and the first device identification pin 123 of the functional chip 12A sequentially. After the query message S1 is received by the functional chip 12A, a response signal S2 corresponding to the query message S1 is transmitted from the functional chip 12A to the computer system 2 through the second device identification pin 124 of the functional chip 12A, the D+ 113 pin of the USB socket 11A and the USB cable 3 sequentially. After the process of communicating the computer system 2 with the functional chip 12A, the specification of the electronic device 1A (e.g. a high speed electronic device 1A or a low speed electronic device 1A) is identified by the computer system 2. Consequently, the subsequent data transmission process may be performed.

FIG. 2 is a schematic circuit block diagram illustrating an electronic device without the function of exchanging data with a computer system according to the prior art. Except that the D+ pin 113 and the D− pin 112 of the USB socket 11B are in the floating state and the functional chip 12B does not have the first device identification pin and the second device identification pin, the configurations of the electronic device 1B are similar to those of the electronic device 1B, and are not redundantly described herein. Consequently, the electronic device 1B of FIG. 2 is only able to receive the electric power from the computer system 2 through the USB socket 11B thereof, but does not have the function of exchanging data with the computer system 2.

Hereinafter, a conventional method of loading firmware to an electronic device will be illustrated with reference to FIG. 3. FIG. 3 is a schematic circuit block diagram illustrating an electronic device implementing a firmware loading method according to the prior art. Except that the functional chip 12C of the electronic device 1C further comprises a first chip data transmission pin 121 and a second chip data transmission pin 122, the configurations of the electronic device 1C are similar to those of the electronic devices of FIGS. 1 and 2, and are not redundantly described herein. Generally, the first chip data transmission pin 121 and the second chip data transmission pin 122 are the pins of an inter-integrated circuit (I²C) interface. For example, the first chip data transmission pin 121 and the second chip data transmission pin 122 are a serial data line (SDA) pin and a serial clock line (SCL) pin, respectively. Alternatively, the first chip data transmission pin 121 and the second chip data transmission pin 122 are the pins of a universal asynchronous receiver/transmitter (UART) interface. For example, the first chip data transmission pin 121 and the second chip data transmission pin 122 are an Rx pin and a Tx pin, respectively.

When a researcher of the electronic device 1C wants to input the firmware into the functional chip 12C or wants to refresh the firmware of the functional chip 12C, an external fixture plate 4 storing the firmware is connected with the first chip data transmission pin 121 and the second chip data transmission pin 122 of the functional chip 12C of the functional chip 12C through connecting wires 41 and 42. Consequently, the firmware can be transmitted from the external fixture plate 4 to the functional chip 12C. However, the above firmware loading method is very complicated. In addition, since the connecting wires 41 and 42 should be specially welded between the functional chip 12C and the external fixture plate 4, the conventional firmware loading method is inconvenient to the researchers in the research branch. Moreover, if a new version of firmware is developed by the manufacturer after the electronic device 1C is introduced into the market, the firmware of the electronic device 1C fails to be refreshed by the user who purchases the electronic device 1C.

Therefore, there is a need of providing an improved electronic device in order to overcome the above drawbacks.

### SUMMARY OF THE INVENTION

The present invention provides an electronic device using a USB socket to load firmware and a firmware loading method. Consequently, the process of loading the firmware into the electronic device by the searcher or the user is simplified.

In accordance with an aspect of the present invention, there is provided an electronic device using a USB socket to load firmware. The electronic device includes the USB socket, a functional chip, and a first switching element. The USB socket includes an identification pin and a first bus data transmission pin. The functional chip executes a specified function. The functional chip includes a first chip data transmission pin. The first switching element is connected between the identification pin, the first bus data transmission pin and the first chip data transmission pin. When the identification pin has a low-level voltage, the first switching element is turned off, so that a connection between the first bus data transmission pin and the first chip data transmission pin is interrupted. When the identification pin has a high-level voltage, the first switching element is triggered to be turned on, so that the connection between the first bus data transmission pin and the first chip data transmission pin is established.

In accordance with another aspect of the present invention, there is provided a firmware loading method of an electronic device for inputting a firmware data into a functional chip of the electronic device. The electronic device includes a USB socket. The firmware loading method includes the following steps. Firstly, a high-level voltage is provided to an identification pin of the USB socket to turn on a first switching element between a first bus data transmission pin of the USB socket and a first chip data transmission pin of the functional chip, so that a connection between the first bus data transmission pin and the first chip data transmission pin is established. Then, the firmware data is transmitted to the functional chip through the first bus data transmission pin and the first chip data transmission pin sequentially.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic circuit block diagram illustrating an electronic device with a function of exchanging data with a computer system according to the prior art;

FIG. 2 is a schematic circuit block diagram illustrating an electronic device without the function of exchanging data with a computer system according to the prior art;

FIG. 3 is a schematic circuit block diagram illustrating an electronic device implementing a firmware loading method according to the prior art;

FIG. 4 is a schematic circuit block diagram illustrating an electronic device using a USB socket to load firmware according to an embodiment of the present invention;

FIG. 5 is a schematic circuit block diagram illustrating the connection between the electronic device of FIG. 4 and a power-providing device;

FIG. 6 is a schematic circuit diagram illustrating a part of the firmware loading circuit of the electronic device of FIG. 4;

FIG. 7 is a schematic circuit diagram illustrating another part of the firmware loading circuit of the electronic device of FIG. 4;

FIG. 8 is a flowchart illustrating a firmware loading method of an electronic device according to an embodiment of the present invention;

FIG. 9 schematically illustrates the use of the firmware loading method of FIG. 8 to load firmware to the functional chip of the electronic device; and

FIG. 10 is a flowchart illustrating a firmware loading method of an electronic device according to another embodiment of the present invention.

### DETAILED DESCRIPTION OF THE PREFERRED EMBODIMENT

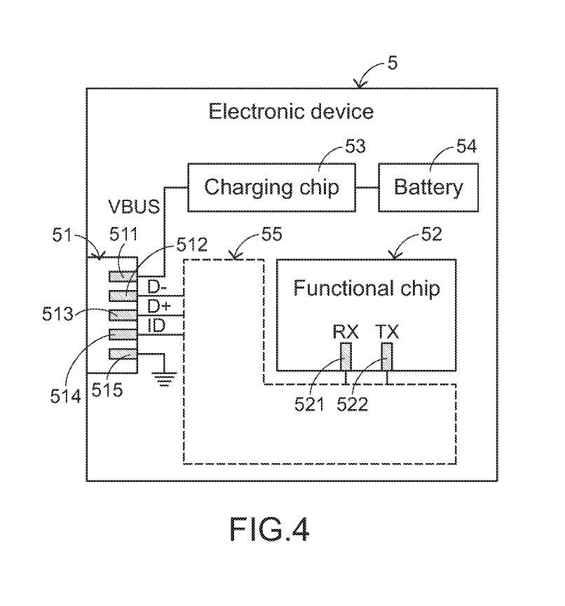

FIG. 4 is a schematic circuit block diagram illustrating an electronic device using a USB socket to load firmware according to an embodiment of the present invention. As shown in FIG. 4, the electronic device 5 comprises a universal serial bus (USB) socket 51, a functional chip 52, a charging chip 53, a battery 54, and a firmware loading circuit 55. The battery 54 is connected with the charging chip 53. The firmware loading circuit 55 is connected between the USB socket 51 and the functional chip 52. Moreover, the functional chip 52 comprises firmware for executing specified functions. For example, in case that the electronic device 5 is a wireless charging device, the functional chip 52 is responsible for implementing a wireless charging operation. Moreover, the functional chip 52 further comprises a first chip data transmission pin 521 and a second chip data transmission pin 522. The USB socket 51 comprises a VBUS pin 511, a first bus data transmission pin 512, a second bus data transmission pin 513, an identification pin 514, and a GND_DRAIN pin 515.

In this embodiment, the USB socket 51 is a Micro USB socket, the identification pin 514 is an ID pin, the first bus data transmission pin 512 is a D− pin, and the second bus data transmission pin 513 is a D+ pin. In this embodiment, the first chip data transmission pin 521 and the second chip data transmission pin 522 are the pins of a universal asynchronous receiver/transmitter (UART) interface. For example, the first chip data transmission pin 521 and the second chip data transmission pin 522 are an Rx pin and a Tx pin, respectively. It is noted that numerous modifications and alterations may be made while retaining the teachings of the invention. For example, in some other embodiments, the first chip data transmission pin 521 and the second chip data transmission pin 522 are the pins of an inter-integrated circuit (I²C) interface. Under this circumstance, the first chip data transmission pin 521 and the second chip data transmission pin 522 are a serial data line (SDA) pin and a serial clock line (SCL) pin, respectively.

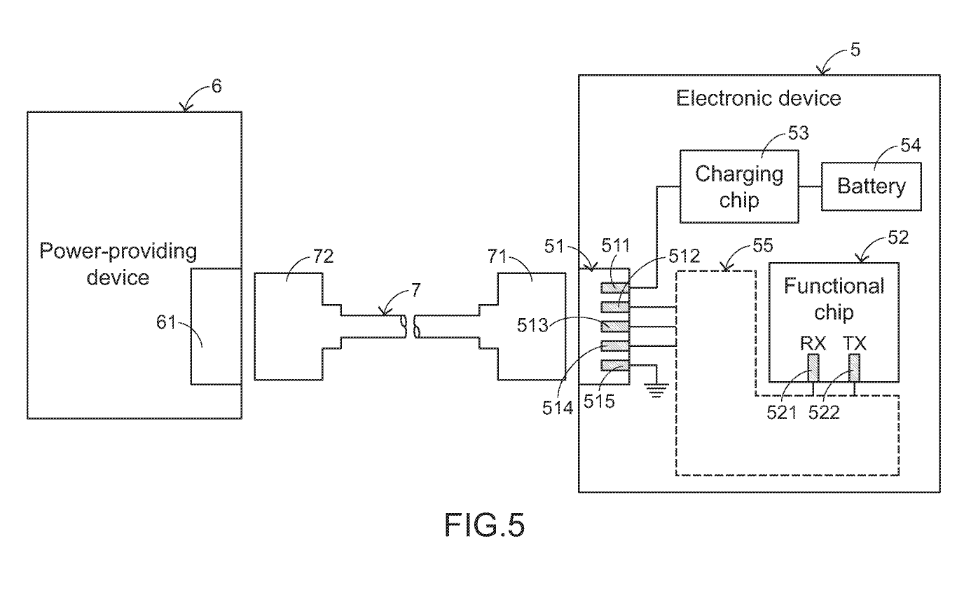

FIG. 5 is a schematic circuit block diagram illustrating the connection between the electronic device of FIG. 4 and a power-providing device. The power-providing device 6 may provide electric power. An example of the power-providing device 6 includes but is not limited to a computer system or a portable power supply. Moreover, the power-providing device 6 comprises a USB socket 61. When two plugs 71 and 72 at both ends of a USB cable 7 are respectively plugged into the USB socket 51 of the electronic device 5 and the USB socket 61 of the power-providing device 6, the electronic device 5 is connected with the power-providing device 6 through the USB cable 7. Under this circumstance, the electric current provided by the power-providing device 6 may be transmitted to the charging chip 53 through the VBUS pin 511 of the USB socket 51 in order to charge the battery 54. Generally, in case that the USB interface is a USB2.0 interface, the power-providing device 6 is able to provide an electric current of about 500 mA to the electronic device 5. Whereas, in case that the USB interface is a USB3.0 interface, the power-providing device 6 is able to provide an electric current of about 900 mA to the electronic device 5.

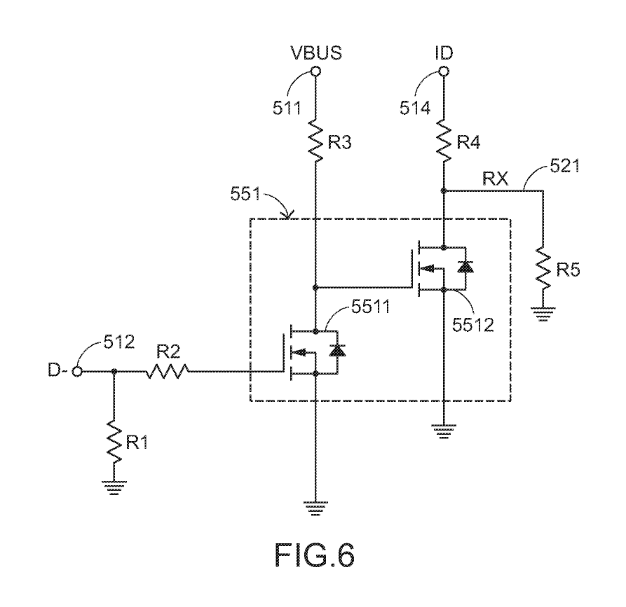

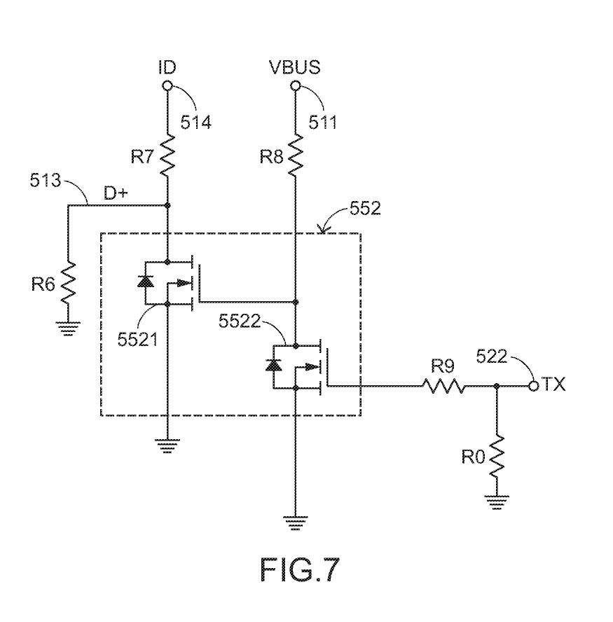

FIG. 6 is a schematic circuit diagram illustrating a part of the firmware loading circuit of the electronic device of FIG. 4. FIG. 7 is a schematic circuit diagram illustrating another part of the firmware loading circuit of the electronic device of FIG. 4. As shown in FIGS. 6 and 7, the firmware loading circuit comprises a first switching element 551, a second switching element 552, and plural resistors R0˜R9. The first switching element 551 is connected between the identification pin 514, the first bus data transmission pin 512, the first chip data transmission pin 521 and the VBUS pin 511. The second switching element 552 is connected between the identification pin 514, the second bus data transmission pin 513, the second chip data transmission pin 522 and the VBUS pin 511. In case that the identification pin 514 has a low-level voltage, the first switching element 551 and the second switching element 552 are turned off. Under this circumstance, the first bus data transmission pin 512 and the second bus data transmission pin 513 are in a floating state or a ground state. Consequently, the connection between the first bus data transmission pin 512 and the first chip data transmission pin 521 is interrupted, and the connection between the second bus data transmission pin 513 and the second chip data transmission pin 522 is interrupted. In case that the identification pin 514 has a high-level voltage, the first switching element 551 and the second switching element 552 are triggered to be turned on. Under this circumstance, the connection between the first bus data transmission pin 512 and the first chip data transmission pin 521 is established, and the connection between the second bus data transmission pin 513 and the second chip data transmission pin 522 is established. In this embodiment, the first switching element 551 comprises a transistor 5511 and a transistor 5512, and the second switching element 552 comprises a transistor 5521 and a transistor 5522. The constituents of the first switching element 551 and the second switching element 552 are not restricted thereto.

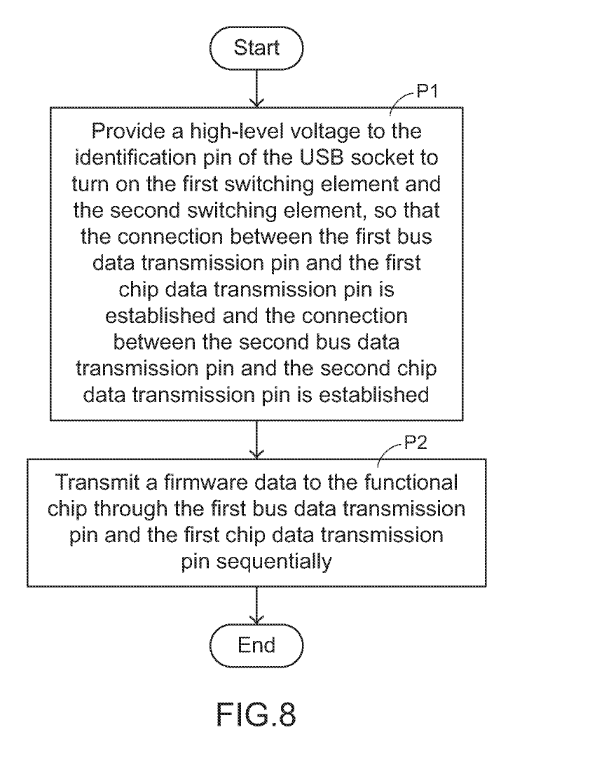

Hereinafter, a firmware loading method of an electronic device of the present invention will be illustrated with reference to FIG. 8. FIG. 8 is a flowchart illustrating a firmware loading method of an electronic device according to an embodiment of the present invention. The firmware loading method comprises the following steps. In a step P1, a high-level voltage is provided to the identification pin 514 of the USB socket 51 to turn on the first switching element 551 and the second switching element 552, so that the connection between the first bus data transmission pin 512 and the first chip data transmission pin 521 is established and the connection between the second bus data transmission pin 513 and the second chip data transmission pin 522 is established. In a step P2, a firmware data is transmitted to the functional chip 52 through the first bus data transmission pin 512 and the first chip data transmission pin 521 sequentially.

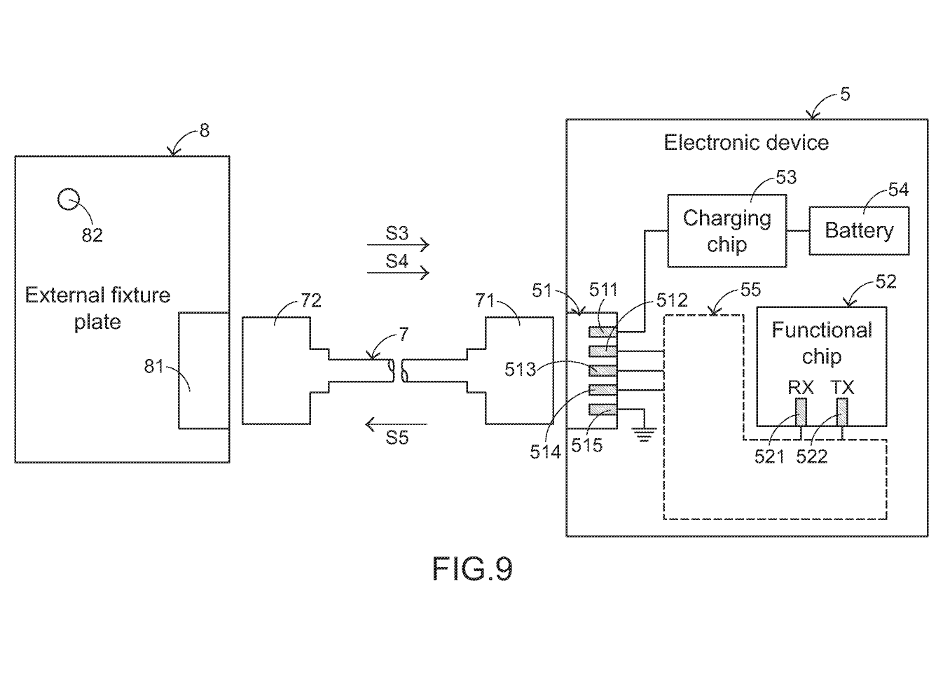

FIG. 9 schematically illustrates the use of the firmware loading method of FIG. 8 to load firmware to the functional chip of the electronic device. An external fixture plate 8 (i.e. another electronic device) stores the firmware data that is required for the electronic device 5. The external fixture plate 8 comprises a USB socket 81 and a switch button 82. When a researcher or a user of the electronic device 5 wants to input the firmware into the functional chip 52 or wants to refresh the firmware of the functional chip 52, two plugs 71 and 72 at both ends of a USB cable 7 are respectively plugged into the USB socket 51 of the electronic device 5 and the USB socket 81 of the external fixture plate 8. Consequently, the electronic device 5 and the external fixture plate 8 are connected with each other through the USB cable 7.

Moreover, when the switch button 82 is triggered by the researcher or the user, the external fixture plate 8 provides the high-level voltage. The high-level voltage is transmitted to the identification pin 514 of the USB socket 51 through the USB cable 7. Consequently, the first switching element 551 and the second switching element 552 are triggered to be turned on. Under this circumstance, the connection between the first bus data transmission pin 512 and the first chip data transmission pin 521 is established, and the connection between the second bus data transmission pin 513 and the second chip data transmission pin 522 is established. Meanwhile, the step P1 of FIG. 8 is performed. Since the connection between the first bus data transmission pin 512 and the first chip data transmission pin 521 is established, the firmware data S3 stored in the external fixture plate 8 may be transmitted to the functional chip 52 through the USB cable 7, the first bus data transmission pin 512 and the first chip data transmission pin 521 sequentially. Meanwhile, the step P2 of FIG. 8 is performed.

During the firmware loading process of the electronic device 5 as shown in FIG. 9, the second bus data transmission pin 513 and the second switching element 552 are not used. Consequently, the step P1 of the firmware loading method as shown in FIG. 8 may be simplified. For example, when the high-level voltage is provided to the identification pin 514 of the USB socket 51, only the first switching element 551 is turned on. Moreover, the electronic device 5 of FIG. 4 may be further simplified. That is, the second switching element 552 is omitted, the second bus data transmission pin 513 is in a floating state or a ground state, and the second bus data transmission pin 513 is not connected with the second chip data transmission pin 522.

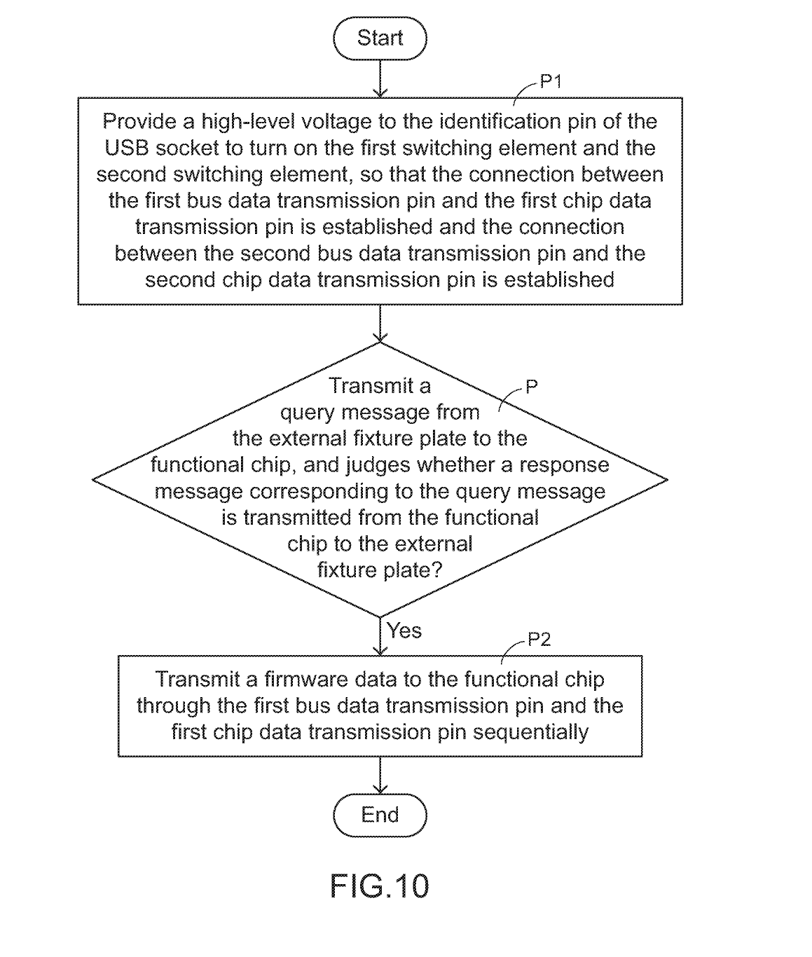

FIG. 10 is a flowchart illustrating a firmware loading method of an electronic device according to another embodiment of the present invention. Except that the firmware loading method of FIG. 10 further comprises a step P between the step P1 and the step P2, the firmware loading method of FIG. 10 is similar to that of FIG. 8, and is not redundantly described herein. In the step P, a query message S4 is transmitted from the external fixture plate 8 to the functional chip 52 through the USB cable 7, the first bus data transmission pin 512 and the first chip data transmission pin 521 sequentially, and the external fixture plate 8 judges whether a response message S5 corresponding to the query message S4 is transmitted from the functional chip 52 to the external fixture plate 8 through the second chip data transmission pin 522, the second bus data transmission pin 513 and the USB cable 7 sequentially. If the judging condition of the step P is satisfied, the step P2 is performed.

From the above descriptions, after the electronic device 5 is connected with the external fixture plate 8 storing the firmware through the USB cable 7 by the researcher or the user, the firmware may be inputted into the functional chip 52 of the electronic device 5 or the firmware of the functional chip 52 may be refreshed. In comparison with the conventional complicated process of welding the connecting wires between the functional chip and the external fixture plate, the firmware loading method of the present invention is simplified and has industrial usefulness.

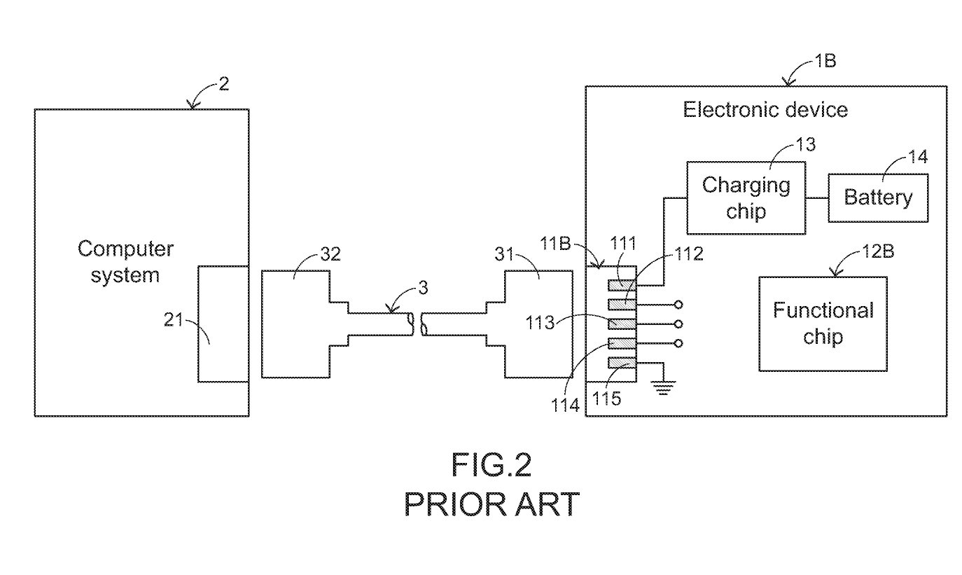

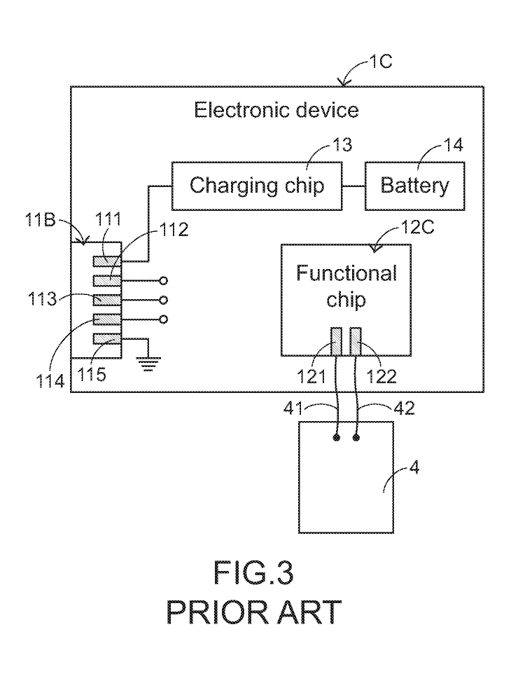

As previously described in the conventional technology of FIGS. 2 and 3, the USB socket 11B of the electronic device 1C is only used as a charging port. That is, the first bus data transmission pin 112, the second bus data transmission pin 113 and the identification pin 114 of the USB socket 11B are three pins that are not functional. By designing the circuitry relationship between the first bus data transmission pin 512, the second bus data transmission pin 513 and the identification pin 514 of the electronic device 5 of the present invention, the USB socket 51 of the electronic device 5 is used as not only the charging port but also the firmware loading and refreshing port.

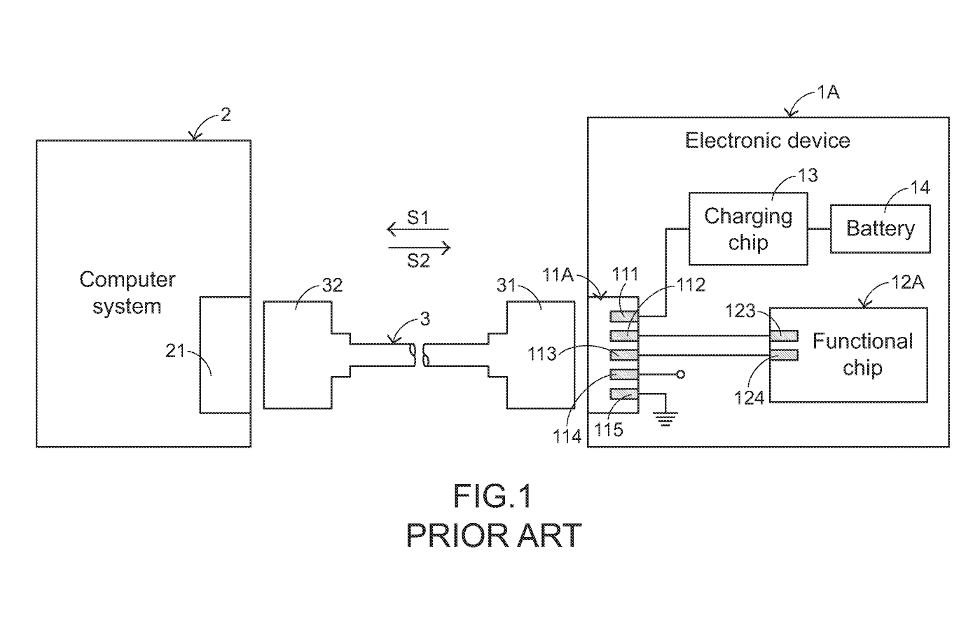

As previously described in the conventional technology of FIG. 1, after the electronic device 1A is connected with the computer system 2 through the USB cable 3, a process of communicating the computer system 2 with the functional chip 12A is performed in order to realize the specification of the electronic device 1A. In accordance with the present invention, the first bus data transmission pin 512 of the USB socket 51 of the electronic device 5 is not connected to the first device identification pin of the functional chip 52, the second bus data transmission pin 513 of the USB socket 51 of the electronic device 5 is not connected to the second device identification pin of the functional chip 52, or even the functional chip 52 of the functional chip 52 does not comprise the first device identification pin and the second device identification pin. Consequently, if the first bus data transmission pin 512 and the second bus data transmission pin 513 of the USB socket 51 are not in the floating state or the ground state when the electronic device 5 is connected with the computer system, the computer system may erroneously judge that the electronic device 5 is an unidentified device. Under this circumstance, the computer system fails to charge the electronic device 5.

For avoiding the occurrence of erroneous judgment, the firmware loading method of the present invention judges whether the connection between the first bus data transmission pin 512 and the first chip data transmission pin 521 of the functional chip 52 is established and judges whether the connection between the second bus data transmission pin 513 and the second chip data transmission pin 522 of the functional chip 52 is established according to the voltage level of the identification pin 514. That is, when the electronic device 5 is connected with the computer system through the USB cable 7 to be subjected to the charging operation, the identification pin 514 of the USB socket 51 has the low-level voltage. Under this circumstance, the first bus data transmission pin 512 and the second bus data transmission pin 513 of the USB socket 51 are in the floating state or the ground state. Consequently, the electronic device 5 can be successfully charged by the computer system. When the electronic device 5 is connected with the external fixture plate 8 through the USB cable 7 to be subjected to a firmware loading operation, the external fixture plate 8 provides the high-level voltage to the identification pin 514 of the USB socket 51. Under this circumstance, the connection between the first bus data transmission pin 512 and the first chip data transmission pin 521 of the functional chip 52 is established, and the connection between the second bus data transmission pin 513 and the second chip data transmission pin 522 of the functional chip 52 is established. Consequently, the firmware data can be successfully transmitted from the external fixture plate 8 to the functional chip 52.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An electronic device using a USB socket to load firmware, the electronic device comprising:
the USB socket comprising an identification pin and a first bus data transmission pin;
a functional chip executing a specified function, wherein the functional chip comprises a first chip data transmission pin; and
a first switching element connected between the identification pin, the first bus data transmission pin and the first chip data transmission pin,
wherein when the identification pin has a low-level voltage, the first switching element is turned off, so that a connection between the first bus data transmission pin and the first chip data transmission pin is interrupted, wherein when the identification pin has a high-level voltage, the first switching element is triggered to be turned on, so that the connection between the first bus data transmission pin and the first chip data transmission pin is established.

2. The electronic device according to claim 1, wherein the USB socket further comprises a second bus data transmission pin, and the functional chip further comprises a second chip data transmission pin, wherein the electronic device further comprises a second switching element, and the second switching element is connected between the identification pin, the second bus data transmission pin and the second chip data transmission pin, wherein when the identification pin has the low-level voltage, the second switching element is turned off, so that a connection between the second bus data transmission pin and the second chip data transmission pin is interrupted, wherein when the identification pin has the high-level voltage, the second switching element is triggered to be turned on, so that the connection between the second bus data transmission pin and the second chip data transmission pin is established.

3. The electronic device according to claim 2, wherein the second switching element comprises at least one transistor.

4. The electronic device according to claim 2, wherein the first chip data transmission pin and the second chip data transmission pin are pins of an inter-integrated circuit (I²C) interface or a universal asynchronous receiver/transmitter (UART) interface.

5. The electronic device according to claim 2, wherein a query message is transmitted from an additional electronic device to the functional chip through the first bus data transmission pin and the first chip data transmission pin sequentially, and a response message is transmitted from the functional chip to the additional electronic device through the second chip data transmission pin and the second bus data transmission pin sequentially.

6. The electronic device according to claim 2, wherein the USB socket is a Micro USB socket, the identification pin is an ID pin, the first bus data transmission pin is a D− pin, and the second bus data transmission pin is a D+ pin.

7. The electronic device according to claim 1, wherein when the identification pin has the low-level voltage, the first bus data transmission pin is in a floating state or a ground state.

8. The electronic device according to claim 1, wherein the first switching element comprises at least one transistor.

9. The electronic device according to claim 1, wherein a firmware data is transmitted from an additional electronic device to the functional chip through the first bus data transmission pin and the first chip data transmission pin sequentially.

10. The electronic device according to claim 9, wherein the additional electronic device is a computer system or an external fixture plate.

11. The electronic device according to claim 2, further comprising a charging chip and a battery, wherein the battery is connected with the charging chip, and the charging chip executes a charging function, wherein the USB socket further comprises a VBUS pin, and the VBUS pin is connected with the charging chip.

12. A firmware loading method of an electronic device for inputting a firmware data into a functional chip of the electronic device, the electronic device comprising a USB socket, the firmware loading method comprising steps of:
(a) providing a high-level voltage to an identification pin of the USB socket to turn on a first switching element between a first bus data transmission pin of the USB socket and a first chip data transmission pin of the functional chip, so that a connection between the first bus data transmission pin and the first chip data transmission pin is established; and
(b) transmitting the firmware data to the functional chip through the first bus data transmission pin and the first chip data transmission pin sequentially.

13. The firmware loading method according to claim 12, wherein when the high-level voltage is provided to the identification pin of the USB socket, a second switching element connected between a second bus data transmission pin of the USB socket and a second chip data transmission pin of the functional chip is turned on, so that a connection between the second bus data transmission pin and the second chip data transmission pin is established.

14. The firmware loading method according to claim 13, wherein when the firmware data is transmitted from an additional electronic device, and the step is after the step (a) and before the step (c), the firmware loading method further comprises a step of issuing a query message from the additional electronic device to the functional chip through the first bus data transmission pin and the first chip data transmission pin sequentially, and judging whether a response message corresponding to the query message is transmitted from the functional chip to the additional electronic device through the second chip data transmission pin and the second bus data transmission pin sequentially, wherein after the response message is transmitted from the functional chip to the additional electronic device, the step (b) is performed.

15. The firmware loading method according to claim 14, wherein the additional electronic device is a computer system or an external fixture plate.

16. The firmware loading method according to claim 13, wherein each of the first switching element and the second switching element comprises at least one transistor.

17. The firmware loading method according to claim 13, wherein the first chip data transmission pin and the second chip data transmission pin are pins of an inter-integrated circuit (I²C) interface or a universal asynchronous receiver/transmitter (UART) interface.

18. The firmware loading method according to claim 13, wherein the USB socket is a Micro USB socket, the identification pin is an ID pin, the first bus data transmission pin is a D− pin, and the second bus data transmission pin is a D+ pin.

19. The firmware loading method according to claim 12, wherein when the identification pin has a low-level voltage, the first bus data transmission pin is in a floating state or a ground state.
